(19) United States
(12) Patent Application Publication
(10) Pub. No.: US 2019/0092983 A1
(43) Pub. Date: Mar. 28, 2019

(54) ADHESIVE TAPE HAVING WAVELENGTH CONVERSION FUNCTION

(71) Applicant: NITTO DENKO CORPORATION, Ibaraki-shi, Osaka (JP)

(72) Inventors: Kozo Nakamura, Ibaraki-shi (JP); Takahiro Yoshikawa, Ibaraki-shi (JP); Kazuhito Hosokawa, Ibaraki-shi (JP)

(73) Assignee: NITTO DENKO CORPORATION, Ibaraki-shi, Osaka (JP)

(21) Appl. No.: 16/085,845

(22) PCT Filed: Mar. 15, 2017
(86) PCT No.: PCT/JP2017/010351

§ 371 Date: Sep. 17, 2018

(30) Foreign Application Priority Data
Mar. 18, 2016 (JP) 2016-056171

(51) Int. Cl. C09J 11/04; C09J 7/38; C09J 11/06; C09J 7/50; G02F 1/1333

(52) U.S. Cl. CPC C09J 11/04; G02F 2202/10; C09J 7/385; C09J 11/06; C09J 7/50; G02F 1/1333; C09J 2423/00; C09J 2433/00; C09J 2467/006; C09J 2203/318; C09J 2205/102; C09J 2400/12; G02F 2202/28; G02F 2202/36; C09J 7/383

(57) ABSTRACT

There is provided a pressure-sensitive adhesive tape having a predetermined wavelength conversion function and having excellent durability. A pressure-sensitive adhesive tape according to the present invention includes: a base material; and a pressure-sensitive adhesive layer having a wavelength conversion function. The base material has a water vapor transmission rate of 1 g/(m²·day) or less. In one embodiment, the pressure-sensitive adhesive layer contains a rubber-based polymer selected from a styrene-based thermoplastic elastomer, an isobutylene-based polymer, and a combination thereof. In one embodiment, the pressure-sensitive adhesive layer contains at least two wavelength conversion materials including a first wavelength conversion material and a second wavelength conversion material, and the first wavelength conversion material has a center emission wavelength in a wavelength band ranging from 515 nm to 550 nm, and the second wavelength conversion material has a center emission wavelength in a wavelength band ranging from 605 nm to 650 nm.

### TECHNICAL FIELD

The present invention relates to a pressure-sensitive adhesive tape having a wavelength conversion function. More specifically, the present invention relates to a pressure-sensitive adhesive tape including a base material having a barrier function and a pressure-sensitive adhesive layer having a wavelength conversion function.

### BACKGROUND ART

In recent years, in order to enhance color reproducibility of a liquid crystal display apparatus, there has been developed a technology using red (R), green (G), and blue (B) monochromatic light sources in combination as backlight light sources. In a liquid crystal display apparatus using such RGB light sources, a pressure-sensitive adhesive tape is sometimes used particularly for preventing light leakage of the blue (B) light source. Specifically, the pressure-sensitive adhesive tape may be used in a peripheral edge portion on a back side of a polarizing plate in a portable liquid crystal display apparatus, such as a smartphone, or in a portion corresponding to a peripheral edge portion of a light guide plate in a large-size liquid crystal display apparatus, such as a liquid crystal television set. From the viewpoint of preventing light leakage, it is preferred that the pressure-sensitive adhesive tape have a predetermined wavelength conversion function. However, the pressure-sensitive adhesive tape having the wavelength conversion function has a problem in that its durability is extremely insufficient, and as a result, an image characteristic of the liquid crystal display apparatus is deteriorated over time.

### CITATION LIST

### Patent Literature

[PTL 1] JP 09-176590 A

### SUMMARY OF INVENTION

### Technical Problem

The present invention has been made in order to solve the problem of the related art described above, and an object of the present invention is to provide a pressure-sensitive adhesive tape having a predetermined wavelength conversion function and having excellent durability.

### Solution to Problem

A pressure-sensitive adhesive tape according to an embodiment of the present invention includes: a base material; and a pressure-sensitive adhesive layer having a wavelength conversion function. The pressure-sensitive adhesive tape is configured to absorb light having a predetermined wavelength, and emit light having a wavelength different from the predetermined wavelength. The base material has a water vapor transmission rate of 1 g/(m²·day) or less.

In one embodiment of the present invention, the pressure-sensitive adhesive layer contains a rubber-based polymer selected from a styrene-based thermoplastic elastomer, an isobutylene-based polymer, and a combination thereof.

In one embodiment of the present invention, the pressure-sensitive adhesive layer contains at least one wavelength conversion material having a center emission wavelength in a wavelength band ranging from 515 nm to 650 nm.

In one embodiment of the present invention, the pressure-sensitive adhesive layer contains at least two wavelength conversion materials including a first wavelength conversion material and a second wavelength conversion material, and the first wavelength conversion material has a center emission wavelength in a wavelength band ranging from 515 nm to 550 nm, and the second wavelength conversion material has a center emission wavelength in a wavelength band ranging from 605 nm to 650 nm.

In one embodiment of the present invention, the pressure-sensitive adhesive layer contains a layered silicate subjected to organizing treatment.

In one embodiment of the present invention, the pressure-sensitive adhesive layer has a water vapor transmission rate in terms of a thickness of 50 μm of 100 g/(m²·day) or less.

In one embodiment of the present invention, the pressure-sensitive adhesive layer has a thickness of 20 μm or more.

A pressure-sensitive adhesive tape according to another embodiment of the present invention prevents light leakage of a liquid crystal display apparatus having a wavelength conversion function. The pressure-sensitive adhesive tape includes the following property: an emission intensity obtained when light having a predetermined wavelength enters the pressure-sensitive adhesive tape is equal to or lower than an emission intensity obtained through the wavelength conversion function of the liquid crystal display apparatus when light having the predetermined wavelength enters the liquid crystal display apparatus.

### Advantageous Effects of Invention

According to the present invention, the pressure-sensitive adhesive layer is formed by blending a pressure-sensitive adhesive with a wavelength conversion material and the base material is configured to have a moisture vapor transmission rate within a predetermined range, and thus the pressure-sensitive adhesive tape having a predetermined wavelength conversion function and having excellent durability can be achieved.

### BRIEF DESCRIPTION OF DRAWINGS

FIG. 1 is a schematic cross-sectional view for illustrating a pressure-sensitive adhesive tape according to one embodiment of the present invention.

FIG. 2 is a schematic cross-sectional view for illustrating a pressure-sensitive adhesive tape according to another embodiment of the present invention.

### DESCRIPTION OF EMBODIMENTS

A. Entire Configuration of Pressure-Sensitive Adhesive Tape

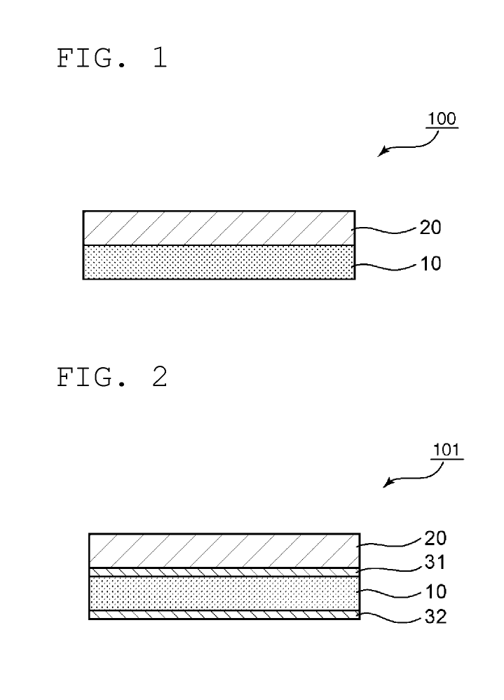

FIG. 1 is a schematic cross-sectional view for illustrating a pressure-sensitive adhesive tape according to one embodiment of the present invention. A pressure-sensitive adhesive tape 100 includes a base material (i.e., a base material layer) 10 and a pressure-sensitive adhesive layer 20. The pressure-sensitive adhesive layer 20 has a wavelength conversion function. As a result, the pressure-sensitive adhesive tape 100 has a wavelength conversion function as a whole. That is, the pressure-sensitive adhesive tape 100 is capable of absorbing light having a predetermined wavelength, and emitting light having a wavelength different from the predetermined wavelength.

The base material 10 has a barrier function against oxygen and/or water vapor. The phrase “has a barrier function” as used herein means controlling the transmission amount of oxygen and/or water vapor penetrating into the pressure-sensitive adhesive layer to substantially shield a wavelength conversion material (to be described later) in the pressure-sensitive adhesive layer therefrom. In embodiments of the present invention, the base material 10 preferably has a water vapor transmission rate of 1 g/(m²·day) or less. As illustrated in FIG. 2, a barrier layer may be arranged on at least one side of the base material 10. In the illustrated example, barrier layers 31 and 32 are arranged on both sides of the base material 10. The barrier layer is preferably arranged at least on the inner side of the base material. When the barrier layer is formed, a desired barrier function for the pressure-sensitive adhesive layer (substantially the wavelength conversion material in the pressure-sensitive adhesive layer) can be achieved while physical and mechanical characteristics desired for a base material are maintained.

The pressure-sensitive adhesive layer 20 typically includes a pressure-sensitive adhesive serving as a matrix and a wavelength conversion material dispersed in the pressure-sensitive adhesive. The pressure-sensitive adhesive layer 20 may contain only one kind of wavelength conversion material, or may contain two or more kinds (e.g., two kinds, three kinds, or four or more kinds) of wavelength conversion materials. In one embodiment, the pressure-sensitive adhesive layer may preferably contain at least one wavelength conversion material having a center emission wavelength in a wavelength band ranging from 515 nm to 650 nm. In another embodiment, the pressure-sensitive adhesive layer may contain two kinds of wavelength conversion materials (a first wavelength conversion material and a second wavelength conversion material). In this case, the first wavelength conversion material preferably has a center emission wavelength in a wavelength band ranging from 515 nm to 550 nm, and the second wavelength conversion material preferably has a center emission wavelength in a wavelength band ranging from 605 nm to 650 nm. Therefore, the first wavelength conversion material can be excited by excitation light (in the present invention, light from a backlight light source) to emit green light, and the second wavelength conversion material can be excited by the excitation light to emit red light. The formation of a pressure-sensitive adhesive layer configured to extract red light and green light having center emission wavelengths in such wavelength bands can impart a desired wavelength conversion function to the pressure-sensitive adhesive tape as a whole.

In practical use, a separator (not shown) may be temporarily bonded to the surface of the pressure-sensitive adhesive layer 20 to protect the pressure-sensitive adhesive layer 20 until the pressure-sensitive adhesive tape 100 or a pressure-sensitive adhesive tape 101 is used.

The pressure-sensitive adhesive tape according to each of the embodiments of the present invention can extremely satisfactorily function as a tape for preventing light leakage of a liquid crystal display apparatus. For example, when blue light from a light source of the liquid crystal display apparatus leaks, the pressure-sensitive adhesive tape having a wavelength conversion function is bonded to a site where the light leaks, so that the leaking light can be converted into white light to make the single-color light leakage inconspicuous. In one embodiment, the pressure-sensitive adhesive tape may be used for preventing light leakage of a liquid crystal display apparatus having a wavelength conversion function. In this case, an emission intensity obtained when light having a predetermined wavelength enters the pressure-sensitive adhesive tape is equal to or lower than an emission intensity obtained through the wavelength conversion function of the liquid crystal display apparatus when light having the predetermined wavelength enters the liquid crystal display apparatus. That is, when the wavelength conversion function (emission intensity) of the pressure-sensitive adhesive tape is greater than that of a sheet or the like having a wavelength conversion function originally incorporated in the liquid crystal display apparatus, the portion in which the pressure-sensitive adhesive tape is bonded becomes brighter, and hence the light leakage-preventing effect is not sufficient in some cases. With the configuration as described above, such problem can be prevented.

B. Base Material

B-1. Base Material

The base material 10 may be formed of any appropriate material capable of forming a base material of a pressure-sensitive adhesive tape. The material for forming the base material is typically a resin. The resin may preferably have a barrier function, transparency, and/or optical isotropy. Specific examples of such resin include a cyclic olefin-based resin, a polycarbonate-based resin, a cellulose-based resin, a polyester-based resin, and an acrylic resin. Of those, a cyclic olefin-based resin (e.g., a norbornene-based resin), a polyester-based resin (e.g., polyethylene terephthalate (PET)), and an acrylic resin (e.g., an acrylic resin having a cyclic structure, such as a lactone ring or a glutarimide ring, in a main chain thereof) are preferred. Those resins can be excellent in balance among the barrier function, the transparency, and the optical isotropy.

The thickness of the base material is preferably from 10 μm to 200 μm, more preferably from 20 μm to 60 μm. With such thickness, mechanical strength and/or flexibility desired for a base material of a pressure-sensitive adhesive tape can be obtained.

As described above, the base material has a barrier function against oxygen and/or water vapor. When the base material has a barrier function, deterioration of the wavelength conversion material of the pressure-sensitive adhesive layer due to oxygen and/or water vapor can be prevented. As a result, a longer life of the wavelength conversion function of the pressure-sensitive adhesive layer can be achieved. The base material may have a barrier function in itself, or may have a barrier layer arranged on at least one side thereof so as to have a barrier function as a laminate of the base material and the barrier layer. The oxygen transmission rate of the base material (when the barrier layer is arranged, the laminate of the base material and the barrier layer) is preferably 10 cm³/(m²·day·atm) or less, more preferably 1 cm³/(m²·day·atm) or less, still more preferably 0.1 cm³/(m²·day·atm) or less. The oxygen transmission rate may be measured under an atmosphere at 25° C. and 0% RH by a measurement method in conformity to JIS K 7126. The water vapor transmission rate (moisture vapor transmission rate) of the base material is preferably 1 g/(m²·day) or less, more preferably 0.1 g/(m²·day) or less, still more preferably 0.01 g/(m²·day) or less. The water vapor transmission rate may be measured under an atmosphere at 40° C. and 90% RH by a measurement method in conformity to JIS K 7129.

B-2. Barrier Layer

The barrier layer can impart an appropriate barrier function to the base material. When the barrier layer is arranged, deterioration of the wavelength conversion material of the pressure-sensitive adhesive layer due to oxygen and/or water vapor can be prevented in a more satisfactory manner.

Examples of the barrier layer include a metal-deposited film, an oxide film, oxynitride film, or nitride film of a metal or silicon, and a metal foil. A metal of the metal-deposited film is, for example, In, Sn, Pb, Cu, Ag, or Ti. A metal oxide is, for example, ITO, IZO, AZO, SiO₂, MgO, SiO, SiₓO_{y}, Al₂O₃, GeO, or TiO₂. The metal foil is, for example, an aluminum foil, a copper foil, or a stainless-steel foil. In addition, an active barrier film may be used as the barrier layer. The active barrier film is a film capable of reacting with oxygen and actively absorbing oxygen. The active barrier film is commercially available. Specific examples of the commercially available product include “Oxyguard” manufactured by Toyobo Co., Ltd., “AGELESS OMAC” manufactured by Mitsubishi Gas Chemical Company, Inc., “OxyCatch” manufactured by Kyodo Printing Co., Ltd., and “EVAL AP” manufactured by Kuraray Co., Ltd.

When the barrier layers 31 and 32 are arranged on both sides of the base material 10 as in FIG. 2, the configurations of the barrier layers 31 and 32 may be identical to or different from each other.

The thickness of the barrier layer is, for example, from 50 nm to 50 μm.

C. Pressure-Sensitive Adhesive Layer

As described above, the pressure-sensitive adhesive layer 10 typically includes a pressure-sensitive adhesive serving as a matrix and a wavelength conversion material dispersed in the pressure-sensitive adhesive.

C-1. Pressure-Sensitive Adhesive

It is preferred that the pressure-sensitive adhesive constituting the matrix have low oxygen permeability and low moisture permeability, have high light stability and high chemical stability, have a predetermined refractive index, have excellent transparency, have optical isotropy, and/or have excellent dispersibility of the wavelength conversion material.

Any appropriate pressure-sensitive adhesive that can have the characteristics as described above may be used as the pressure-sensitive adhesive. Specific examples of the pressure-sensitive adhesive include a rubber-based pressure-sensitive adhesive, an acrylic pressure-sensitive adhesive, a silicone-based pressure-sensitive adhesive, an epoxy-based pressure-sensitive adhesive, and a cellulose-based pressure-sensitive adhesive. Of those, a rubber-based pressure-sensitive adhesive or an acrylic pressure-sensitive adhesive is preferred.

A rubber-based polymer for the rubber-based pressure-sensitive adhesive (pressure-sensitive adhesive composition) is a polymer showing rubber elasticity in a temperature region around room temperature. A rubber-based polymer (A) is preferably, for example, a styrene-based thermoplastic elastomer (A1), an isobutylene-based polymer (A2), or a combination thereof.

Examples of the styrene-based thermoplastic elastomer (A1) may include styrene-based block copolymers, such as a styrene-ethylene-butylene-styrene block copolymer (SEBS), a styrene-isoprene-styrene block copolymer (SIS), a styrene-butadiene-styrene block copolymer (SBS), a styrene-ethylene-propylene-styrene block copolymer (SEPS, hydrogenated product of SIS), a styrene-ethylene-propylene block copolymer (SEP, hydrogenated product of a styrene-isoprene block copolymer), and a styrene-isobutylene-styrene block copolymer (SIBS), and a styrene-butadiene rubber (SBR). Of those, a styrene-ethylene-propylene-styrene block copolymer (SEPS, a hydrogenated product of SIS), a styrene-ethylene-butylene-styrene block copolymer (SEBS), or a styrene-isobutylene-styrene block copolymer (SIBS) is preferred from the viewpoint of having polystyrene blocks at both molecular ends so as to have a high cohesive strength as a polymer. A commercially available product may be used as the styrene-based thermoplastic elastomer (A1). Specific examples of the commercially available product include SEPTON and HYBRAR manufactured by Kuraray Co., Ltd., Tuftec manufactured by Asahi Kasei Chemicals Corporation, and SIBSTAR manufactured by Kaneka Corporation.

The weight-average molecular weight of the styrene-based thermoplastic elastomer (A1) is preferably from about 50,000 to about 500,000, more preferably from about 50,000 to about 300,000, still more preferably from about 50,000 to about 250,000. A case in which the weight-average molecular weight of the styrene-based thermoplastic elastomer (A1) falls within such range is preferred because the cohesive strength and viscoelasticity of the polymer can both be achieved.

The styrene content in the styrene-based thermoplastic elastomer (A1) is preferably from about 5 wt % to about 70 wt %, more preferably from about 5 wt % to about 40 wt %, still more preferably from about 10 wt % to about 20 wt %. A case in which the styrene content in the styrene-based thermoplastic elastomer (A1) falls within such range is preferred because the viscoelasticity exhibited by a soft segment can be secured while the cohesive strength exhibited by a styrene moiety is kept.

An example of the isobutylene-based polymer (A2) may be a polymer containing isobutylene as a constituent monomer and preferably having a weight-average molecular weight (Mw) of 500,000 or more. The isobutylene-based polymer (A2) may be a homopolymer of isobutylene (polyisobutylene, PIB), or may be a copolymer containing isobutylene as a main monomer (i.e., a copolymer having isobutylene copolymerized therein at a ratio of more than 50 mol %). Examples of such copolymer may include a copolymer of isobutylene and n-butylene, a copolymer of isobutylene and isoprene (e.g., a butyl rubber, such as a regular butyl rubber, a chlorinated butyl rubber, a brominated butyl rubber, or a partially cross-linked butyl rubber), and vulcanized products and modified products thereof (e.g., products each obtained by modification with a functional group, such as a hydroxyl group, a carboxyl group, an amino group, or an epoxy group). Of those, polyisobutylene (PIB) is preferred from the viewpoint of being free of a double bond in its main chain so as to be excellent in weatherability. A commercially available product may be used as the isobutylene-based polymer (A2). A specific example of the commercially available product is OPPANOL manufactured by BASF SE.

The weight-average molecular weight (Mw) of the isobutylene-based polymer (A2) is preferably 500,000 or more, more preferably 600,000 or more, still more preferably 700,000 or more. In addition, the upper limit of the weight-average molecular weight (Mw) is preferably 5,000,000 or less, more preferably 3,000,000 or less, still more preferably 2,000,000 or less. When the weight-average molecular weight of the isobutylene-based polymer (A2) is set to 500,000 or more, the pressure-sensitive adhesive composition can be made more excellent in durability under high-temperature storage.

The content of the rubber-based polymer (A) in the pressure-sensitive adhesive (pressure-sensitive adhesive composition) is preferably 30 wt % or more, more preferably 40 wt % or more, still more preferably 50 wt % or more, particularly preferably 60 wt % or more in the total solid content of the pressure-sensitive adhesive composition. The upper limit of the content of the rubber-based polymer is preferably 95 wt % or less, more preferably 90 wt % or less.

In the rubber-based pressure-sensitive adhesive, the rubber-based polymer (A) and another rubber-based polymer may be used in combination. Specific examples of the other rubber-based polymer include: a butyl rubber (IIR), a butadiene rubber (BR), an acrylonitrile-butadiene rubber (NBR), EPR (binary ethylene-propylene rubber), EPT (ternary ethylene-propylene rubber), an acrylic rubber, a urethane rubber, and a polyurethane-based thermoplastic elastomer; a polyester-based thermoplastic elastomer; and a blend-based thermoplastic elastomer, such as a polymer blend of polypropylene and EPT (ternary ethylene-propylene rubber). The blending amount of the other rubber-based polymer is preferably about 10 parts by weight or less with respect to 100 parts by weight of the rubber-based polymer (A).

An acrylic polymer for the acrylic pressure-sensitive adhesive (pressure-sensitive adhesive composition) typically contains an alkyl (meth)acrylate as a main component, and may contain, as a copolymerization component appropriate for a purpose, an aromatic ring-containing (meth)acrylate, an amide group-containing monomer, a carboxyl group-containing monomer, and/or a hydroxyl group-containing monomer. The term “(meth)acrylate” as used herein means acrylate and/or methacrylate. Examples of the alkyl (meth)acrylate may include (meth)acrylates of linear or branched alkyl groups each having 1 to 18 carbon atoms. The aromatic ring-containing (meth)acrylate is a compound containing an aromatic ring structure in its structure, and containing a (meth)acryloyl group therein. Examples of the aromatic ring include a benzene ring, a naphthalene ring, and a biphenyl ring. The aromatic ring-containing (meth)acrylate can satisfy durability (in particular, durability with respect to a transparent conductive layer) and alleviate display unevenness caused by a white void in a peripheral portion. The amide group-containing monomer is a compound containing an amide group in its structure, and containing a polymerizable unsaturated double bond, such as a (meth)acryloyl group or a vinyl group, therein. The carboxyl group-containing monomer is a compound containing a carboxyl group in its structure, and containing a polymerizable unsaturated double bond, such as a (meth)acryloyl group or a vinyl group, therein. The hydroxyl group-containing monomer is a compound containing a hydroxyl group in its structure, and containing a polymerizable unsaturated double bond, such as a (meth)acryloyl group or a vinyl group, therein. The details of the acrylic pressure-sensitive adhesive are described in, for example, JP 2015-199942 A, the description of which is incorporated herein by reference.

C-2. Wavelength Conversion Material

The wavelength conversion material is capable of controlling the wavelength conversion characteristic of the pressure-sensitive adhesive layer. For example, the wavelength conversion material may be quantum dots, or may be a phosphor. In one embodiment, the first wavelength conversion material and the second wavelength conversion material may each be quantum dots. In another embodiment, one of the first wavelength conversion material or the second wavelength conversion material may be quantum dots, the other being a phosphor. For example, the first wavelength conversion material may be quantum dots, the second wavelength conversion material being a phosphor. In still another embodiment, the first wavelength conversion material and the second wavelength conversion material may each be a phosphor.

The content of the wavelength conversion material (when two or more kinds are used, the total content thereof) in the pressure-sensitive adhesive layer is preferably from 0.01 part by weight to 50 parts by weight, more preferably from 0.01 part by weight to 35 parts by weight, still more preferably from 0.01 part by weight to 30 parts by weight with respect to 100 parts by weight of the solid content of the pressure-sensitive adhesive. When the content of the wavelength conversion material falls within such range, a pressure-sensitive adhesive tape capable of satisfactorily preventing light leakage can be achieved.

C-2-1. Quantum Dots

The quantum dots may be used alone or in combination of two or more kinds (e.g., two kinds, three kinds, or four or more kinds) thereof. For example, when quantum dots having different center emission wavelengths are used in appropriate combination, a pressure-sensitive adhesive layer that achieves light having a desired center emission wavelength can be formed. The center emission wavelength of each of the quantum dots may be adjusted on the basis of, for example, the material and/or composition, particle size, and shape of each of the quantum dots. In one embodiment, two kinds of quantum dots (first quantum dots and second quantum dots) may be used. When those quantum dots are appropriately combined, light having a center emission wavelength in a desired wavelength band can be achieved by allowing light having a predetermined wavelength (light from a backlight light source) to enter and pass through the pressure-sensitive adhesive layer. For example, the first quantum dots preferably each have a center emission wavelength in a wavelength band ranging from 515 nm to 550 nm, and the second quantum dots preferably each have a center emission wavelength in a wavelength band ranging from 605 nm to 650 nm. Therefore, the first quantum dots can each be excited by excitation light (in the present invention, light from a backlight light source) to emit green light, and the second quantum dots can each be excited by the excitation light to emit red light. With such configuration, it is possible to prevent light leakage in more satisfactory manner by further combining quantum dots each capable of emitting blue light as required.

The quantum dots may each be formed of any appropriate material. The quantum dots may each be formed of preferably an inorganic material, more preferably an inorganic conductor material or an inorganic semiconductor material. Examples of the semiconductor material include semiconductors of Groups II-VI, Groups III-V, Groups IV-VI, and Group IV. Specific examples thereof include Si, Ge, Sn, Se, Te, B, C (including diamond), P, BN, BP, BAs, AlN, AlP, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Al, Ga, In)₂(S, Se, Te)₃, and Al₂CO. Those semiconductor materials may be used alone or in combination thereof. The quantum dots may each contain a p-type dopant or an n-type dopant. In addition, the quantum dots may each have a core-shell structure. In the core-shell structure, any appropriate functional layer (a single layer or a plurality of layers) may be formed on the periphery of a shell depending on purposes, or the surface of the shell may be subjected to surface treatment and/or chemical modification.

Any appropriate shape may be adopted as the shape of each of the quantum dots depending on purposes. Specific examples thereof include a true spherical shape, a flaky shape, a plate-like shape, an ellipsoidal shape, and an amorphous shape.

Any appropriate size may be adopted as the size of each of the quantum dots depending on a desired emission wavelength. The size of each of the quantum dots is typically from 1 nm to 20 nm, preferably from 1 nm to 10 nm, more preferably from 2 nm to 8 nm. When the size of each of the quantum dots falls within such range, sharp emission is shown for each of green light and red light, and a high color rendering property can be achieved. For example, green light can be emitted when the quantum dots each have a size of about 7 nm, and red light can be emitted when the quantum dots each have a size of about 3 nm. When the quantum dots each have, for example, a true spherical shape, the size of each of the quantum dots is the average particle diameter, and when the quantum dots each have any other shape, the size is a dimension along the shortest axis in the shape.

The details of the quantum dots are described in, for example, JP 2012-169271 A, JP 2015-102857 A, JP 2015-65158 A, JP 2013-544018 A, and JP 2010-533976 A, the descriptions of which are incorporated herein by reference. Commercially available products may be used as the quantum dots.

C-2-2. Phosphor

Any appropriate phosphor capable of emitting light of a desired color depending on purposes may be used as the phosphor. Specific examples thereof include a red phosphor and a green phosphor.

An example of the red phosphor is a complex fluoride phosphor activated with Mn⁴⁺. The complex fluoride phosphor refers to a coordination compound containing at least one coordination center (e.g., M to be described later) surrounded by fluoride ions acting as ligands, in which, as required, electric charge is compensated for by a counterion (e.g., A to be described later). Specific examples thereof include A₂[MF₅]:Mn⁴⁺, A₃[MF₆]:Mn⁴⁺, Zn₂[MF₇]:Mn⁴⁺, A[In₂F₇]:Mn⁴⁺, A₂[M′F₆]:Mn⁴⁺, E[M′F₆]:Mn⁴⁺, A₃[ZrF₇]:Mn⁴⁺, and Ba_{0.65}Zr_{0.35}F_{2.70}:Mn⁴⁺. In the formulae, A represents Li, Na, K, Rb, Cs, or NH₄, or a combination thereof. M represents Al, Ga, or In, or a combination thereof. M′ represents Ge, Si, Sn, Ti, or Zr, or a combination thereof. E represents Mg, Ca, Sr, Ba, or Zn, or a combination thereof. Of those, a complex fluoride phosphor having a coordination number at the coordination center of 6 is preferred. The details of such red phosphor are described in, for example, JP 2015-84327 A, the description of which is incorporated herein by reference in its entirety.

An example of the green phosphor is a compound containing, as a main component, a solid solution of SiAlON having a β-Si₃N₄ crystal structure. Treatment for adjusting the amount of oxygen contained in such SiAlON crystal to a specific amount (e.g., 0.8 mass %) or less is preferably performed. When such treatment is performed, a green phosphor capable of emitting sharp light with a small peak width can be obtained. The details of such green phosphor are described in, for example, JP 2013-28814 A, the description of which is incorporated herein by reference in its entirety.

C-3. Barrier Function

The pressure-sensitive adhesive layer preferably has a barrier function against oxygen and/or water vapor. The pressure-sensitive adhesive layer may express the barrier function by imparting, to the quantum dots themselves, a three-dimensional structure, such as a core-shell structure or a tetrapod-like structure. In addition, the pressure-sensitive adhesive layer may express the barrier function through appropriate selection of the pressure-sensitive adhesive. The pressure-sensitive adhesive layer may preferably express the barrier function by blending a layered silicate subjected to organizing treatment (organized layered silicate). When the pressure-sensitive adhesive layer has the barrier function, a pressure-sensitive adhesive tape having extremely excellent durability while maintaining a desired wavelength conversion function can be achieved by virtue of a synergistic effect with the barrier function of the base material.

The organized layered silicate may be obtained by appropriately subjecting a layered silicate to organizing treatment. The layered silicate has, for example, a laminated structure in which several hundred to several thousand plate crystals (each having, for example, a thickness of 1 nm), each of which is formed of two silica tetrahedral layers, and a magnesium octahedral layer or aluminum octahedral layer present between the two silica tetrahedral layers, are laminated. Examples of the layered silicate include smectite, bentonite, montmorillonite, and kaolinite.

The thickness of the layered silicate is preferably from 0.5 nm to 30 nm, more preferably from 0.8 nm to 10 nm. The length of the long side of the layered silicate is preferably from 50 nm to 1,000 nm, more preferably from 300 nm to 600 nm. The long side of the layered silicate means the longest side out of sides forming the layered silicate.

The aspect ratio of the layered silicate (ratio L/T of its thickness T and the length L of its long side) is preferably 25 or more, more preferably 200 or more. When a layered silicate having a high aspect ratio is used, a pressure-sensitive adhesive layer having high gas barrier properties can be obtained even if the addition amount of the layered silicate is small. In addition, when the addition amount of the layered silicate is small, a pressure-sensitive adhesive layer having high transparency and excellent in flexibility can be obtained. The upper limit of the aspect ratio of the layered silicate is generally 300.

The organized layered silicate is free of coloring even under a temperature of preferably 200° C. or more, more preferably 230° C. or more, still more preferably from 230° C. to 400° C. The organized layered silicate is preferably free of coloring even when heated at 230° C. for 10 minutes. The phrase “free of coloring” as used herein means that the organized layered silicate is free of coloring when visually observed.

The organizing treatment is performed by cation exchange of an inorganic cation (e.g., Na⁺, Ca²⁺, Al³⁺, or Mg²⁺) originally present between the plate crystals in the layered silicate through the use of an appropriate salt serving as an organizing treatment agent. Examples of the organizing treatment agent to be used for the cation exchange include nitrogen-containing heterocyclic quaternary ammonium salts and quaternary phosphonium salts. Of those, a quaternary imidazolium salt, a triphenylphosphonium salt, or the like is preferably used. A layered silicate subjected to the organizing treatment with any of those salts is excellent in heat resistance, and is free of coloring even under high temperature (e.g., 200° C. or more). In addition, the organized layered silicate is excellent in dispersibility in the pressure-sensitive adhesive layer. The use of an organized layered silicate having high dispersibility allows the formation of a pressure-sensitive adhesive layer having high transparency and high gas barrier properties. The quaternary imidazolium salt is more preferably used as the organizing treatment agent. The quaternary imidazolium salt is more excellent in heat resistance, and hence a pressure-sensitive adhesive layer having less coloring even under high temperature can be obtained by using a layered silicate subjected to the organizing treatment with the quaternary imidazolium salt.

The counteranion of the salt to be used as the organizing treatment agent is, for example, Cl⁻, B⁻, or Br⁻. The counteranion is preferably Cl⁻ or B⁻, more preferably Cl⁻. A salt containing such counterion is excellent in exchangeability with the inorganic cation originally present in the layered silicate.

The salt to be used as the organizing treatment agent preferably has a long-chain alkyl group. The alkyl group has preferably 4 or more, more preferably 6 or more, still more preferably 8 to 12 carbon atoms. When a salt having the long-chain alkyl group is used, the salt widens a distance between the plate crystals in the layered silicate to weaken an interaction between the crystals, with the result that the dispersibility of the organized layered silicate is enhanced. When the dispersibility of the organized layered silicate is high, a pressure-sensitive adhesive layer having high transparency and high gas barrier properties can be formed.

The thickness of the organized layered silicate is preferably from 0.5 nm to 30 nm, more preferably from 0.8 nm to 20 nm, still more preferably from 1 nm to 5 nm.

The organized layered silicate may be obtained by, for example, dispersing the layered silicate and the salt serving as the organizing treatment agent in any appropriate solvent (e.g., water), and stirring the dispersion under predetermined conditions. The addition amount of the salt serving as the organizing treatment agent is preferably 1.1 or more, more preferably 1.2 or more, still more preferably 1.5 or more times as large as the amount of the cation originally present in the layered silicate on a molar basis. Whether or not the layered silicate has been subjected to the organizing treatment may be confirmed on the basis of an increase in interlayer distance by measuring the interlayer distance of the layered silicate through X-ray diffraction analysis.

The blending amount of the organized layered silicate is preferably from 1 part by weight to 30 parts by weight, more preferably from 3 parts by weight to 20 parts by weight, still more preferably from 3 parts by weight to 15 parts by weight, particularly preferably from 5 parts by weight to 15 parts by weight with respect to 100 parts by weight of the solid content of the pressure-sensitive adhesive. When the blending amount falls within such range, a pressure-sensitive adhesive layer excellent in gas barrier properties and transparency, and having little coloring can be obtained.

The water vapor transmission rate (moisture vapor transmission rate) of the pressure-sensitive adhesive layer in terms of a thickness of 50 μm is preferably 100 g/(m²·day) or less, more preferably 80 g/(m²·day) or less.

C-4. Others

The pressure-sensitive adhesive layer may further contain any appropriate additive depending on purposes. Examples of the additive include a light diffusing material, a material for imparting anisotropy to light, and a material for polarizing light. Specific examples of the light diffusing material include fine particles each formed of an acrylic resin, a silicone-based resin, a styrene-based resin, or a resin based on a copolymer thereof. Specific examples of the material for imparting anisotropy to light and/or the material for polarizing light include: ellipsoidal fine particles in each of which birefringence on its major axis differs from that on its minor axis; core-shell type fine particles; and laminated fine particles. The kind, number, blending amount, and the like of the additives may be appropriately set depending on purposes.

The pressure-sensitive adhesive layer may be formed by, for example, applying a liquid composition containing the pressure-sensitive adhesive and the wavelength conversion material, and as required, the additive. Any appropriate application method may be used as an application method. Specific examples thereof include a curtain coating method, a dip coating method, a spin coating method, a print coating method, a spray coating method, a slot coating method, a roll coating method, a slide coating method, a blade coating method, a gravure coating method, and a wire bar method. Curing conditions may be appropriately set depending on, for example, the kind of the pressure-sensitive adhesive to be used and the composition of the composition. When the quantum dots are added to the pressure-sensitive adhesive, the quantum dots may be added in a state of particles, or may be added in a state of a dispersion liquid by being dispersed in a solvent.

The pressure-sensitive adhesive layer may be a single layer, or may have a laminated structure. When the pressure-sensitive adhesive layer has a laminated structure, its layers may typically contain wavelength conversion materials having light emission characteristics different from each other.

The thickness of the pressure-sensitive adhesive layer (when the pressure-sensitive adhesive layer has a laminated structure, the total thickness thereof) is preferably from 20 μm to 500 μm, more preferably from 100 μm to 400 μm. When the thickness of the pressure-sensitive adhesive layer falls within such range, a pressure-sensitive adhesive tape excellent in light leakage-preventing performance and durability can be obtained. Further, when the thickness is 20 μm or more, excellent barrier properties can be achieved. When the pressure-sensitive adhesive layer has a laminated structure, the thickness of each of its layers is preferably from 10 μm to 300 μm, more preferably from 20 μm to 250 μm.

### EXAMPLES

Now, the present invention is specifically described byway of Examples. However, the present invention is not limited by these Examples. Measurement methods for characteristics are as described below.

(1) Thickness

The thickness of a barrier layer was measured by observing a cross-section thereof with a transmission electron microscope (H-7650 manufactured by Hitachi, Ltd.). The thicknesses of a base material and a pressure-sensitive adhesive layer were measured with a thickness meter (Digital Dial Gauge DG-205 from Peacock).

(2) Moisture Vapor Transmission Rate

Measurement was performed by a measurement method in conformity to JIS K 7129. Specifically, a base material or a base material with a barrier layer obtained in each of Examples and Comparative Example was cut into a 10 cmφ circle to serve as a measurement sample. The measurement sample was measured for its moisture vapor transmission rate under the test conditions of 40° C. and 90% RH through the use of “DELTAPERM” manufactured by Technolox Ltd.

(3) Wavelength Conversion Performance (Light Leakage-Preventing Characteristic)

A commercially available liquid crystal display apparatus (manufactured by Samsung, product name: “UN65JS9000FXZA”) was dismantled. A pressure-sensitive adhesive tape obtained in each of Examples and Comparative Example was bonded to a frame portion in contact with both ends of the light guide plate of the liquid crystal display apparatus. Then, the backlight of the liquid crystal display apparatus was turned on, and the degree of light leakage in the portion in which the pressure-sensitive adhesive tape was bonded was visually observed.

(4) Durability

The liquid crystal display apparatus having bonded thereto the pressure-sensitive adhesive tape described in (3) above was left to stand in an oven at 85° C. and 85% RH for 24 hours, and then the degree of light leakage in the portion in which the pressure-sensitive adhesive tape was bonded was measured in the same manner as described in (3) above. The measured emission intensity was converted into a relative value with respect to an emission intensity before the endurance test, which was defined as 100.

Further, the state of the pressure-sensitive adhesive layer of the pressure-sensitive adhesive tape after the endurance test was visually observed.

### Example 1

(Production of Base Material with a Barrier Layer)

A commercially available PET film (manufactured by Toyobo Co., Ltd., product name: “COSMOSHINE A4300”, thickness: 100 μm) was used as a base material. AZO and SiO₂ were deposited from the vapor onto one surface of the film to form a barrier layer (total thickness: 0.06 μm). The resultant base material with a barrier layer had a moisture vapor transmission rate of 0.01 g/(m²·day).

(Pressure-Sensitive Adhesive)

100 Parts by weight of polyisobutylene (PIB) serving as a rubber-based polymer was blended with 10 parts by weight of hydrogenated terpene phenol (product name: YS POLYSTER TH130, softening point: 130° C., hydroxyl value: 60, manufactured by Yasuhara Chemical Co., Ltd.) serving as a tackifier, 3 parts by weight of quantum dots, each of which was formed of an InP-based core and had a particle diameter of 10 nm or less and a center emission wavelength of 530 nm, serving as a green wavelength conversion material, and 0.3 part by weight of quantum dots, each of which was formed of an InP-based core and had a particle diameter of 20 nm or less and a center emission wavelength of 630 nm, serving as a red wavelength conversion material, and the solid content was adjusted with a toluene solvent to 18 wt %. Thus, a pressure-sensitive adhesive composition (solution) containing wavelength conversion materials was prepared.

(Production of Pressure-Sensitive Adhesive Tape)

The pressure-sensitive adhesive prepared above was applied to the barrier layer surface of the base material with a barrier layer obtained above with an applicator to forma pressure-sensitive adhesive layer. The pressure-sensitive adhesive layer had a thickness of 50 μm and a moisture vapor transmission rate of 10 g/(m²·day). Thus, a pressure-sensitive adhesive tape was produced. The evaluations described in (3) and (4) above were performed using the resultant pressure-sensitive adhesive tape. The results are shown in Table 1.

### Example 2

A pressure-sensitive adhesive tape was produced in the same manner as in Example 1 except that the pressure-sensitive adhesive layer was formed using an acrylic pressure-sensitive adhesive in place of the rubber-based pressure-sensitive adhesive. The acrylic pressure-sensitive adhesive was prepared as described below. The pressure-sensitive adhesive layer had a thickness of 50 μm and a moisture vapor transmission rate of 5 g/(m²·day).

100 Parts by weight of an acrylic polymer described in JP 2549388 B2 was blended with 0.15 part of dibenzoyl peroxide (manufactured by Nippon Oil & Fats Co., Ltd.: NYPER BO-Y), 0.02 part of trimethylolpropane-xylylene diisocyanate (Mitsui Takeda Chemicals, Inc.: TAKENATE D110N), and 0.2 part of a silane coupling agent (manufactured by Soken Chemical & Engineering Co., Ltd.: A-100, acetoacetyl group-containing silane coupling agent) to prepare the acrylic pressure-sensitive adhesive. With respect to 100 parts by weight of the acrylic polymer, 3 parts by weight of quantum dots, each of which was formed of an InP-based core and had a particle diameter of 10 nm or less and a center emission wavelength of 530 nm, serving as a green wavelength conversion material, 0.3 part by weight of quantum dots, each of which was formed of an InP-based core and had a particle diameter of 20 nm or less and a center emission wavelength of 630 nm, serving as a red wavelength conversion material, and 10 parts by weight of a nanoclay (organized layered silicate) described in Example 1 of JP 2015-183078 A were blended, and the solid content was adjusted with a toluene solvent to 18 wt %.

Evaluations were performed in the same manner as in Example 1 using the resultant pressure-sensitive adhesive tape. The results are shown in Table 1.

### Comparative Example 1

A pressure-sensitive adhesive tape was produced in the same manner as in Example 1 except that the PET film was not subjected to the vapor deposition treatment. The base material had a moisture vapor transmission rate of 11.3 g/(m²·day). Evaluations were performed in the same manner as in Example 1 using the resultant pressure-sensitive adhesive tape. The results are shown in Table 1.

TABLE 1

| | | | Moisture vapor | | | |
|---|---|---|---|---|---|---|
| | Moisture | Thickness of | transmission | Visual | Visual | |
| | vapor | pressure- | rate of | judgment | judgment | |
| | transmission | sensitive | pressure- | before | after | |
| | rate of base | adhesive | sensitive | endurance | endurance | External |
| | material | layer (μm) | adhesive layer | test | test | appearance |
| Example 1 | 0.01 | 50 | 10 | ∘ | ∘ | Unchanged |
| Example 2 | 0.01 | 50 | 5 | ∘ | ∘ | Unchanged |
| Comparative | 11.3 | 50 | 10 | ∘ | x | Foaming |
| Example 1 | | | | | | |

*Unit of moisture vapor transmission rate: g/(m² · day)
*Symbol “∘” means “good” and symbol “x” means “bad”.

<Evaluation>

As is apparent from Table 1, it is found that the pressure-sensitive adhesive tape of each of Examples of the present invention has an excellent light leakage-preventing function and excellent durability.

### INDUSTRIAL APPLICABILITY

The pressure-sensitive adhesive tape of the present invention can be suitably used as a tape for preventing light leakage of a liquid crystal display apparatus. The liquid crystal display apparatus using such pressure-sensitive adhesive tape can be used for various applications, such as portable devices including a personal digital assistant (PDA), a cellular phone, a watch, a digital camera, and a portable gaming machine, OA devices including a personal computer monitor, a notebook-type personal computer, and a copying machine, electric home appliances including a video camera, a liquid crystal television set, and a microwave oven, on-board devices including a reverse monitor, a monitor for a car navigation system, and a car audio, exhibition devices including an information monitor for a commercial store, security devices including a surveillance monitor, and caring/medical devices including a caring monitor and a medical monitor.

### REFERENCE SIGNS LIST

10 base material
20 pressure-sensitive adhesive layer
31 barrier layer
32 barrier layer
100 pressure-sensitive adhesive tape
101 pressure-sensitive adhesive tape

1. A pressure-sensitive adhesive tape, comprising:
a base material; and
a pressure-sensitive adhesive layer having a wavelength conversion function,
the pressure-sensitive adhesive tape being configured to absorb light having a predetermined wavelength, and emit light having a wavelength different from the predetermined wavelength,
wherein the base material has a water vapor transmission rate of 1 g/(m²·day) or less.

2. The pressure-sensitive adhesive tape according to claim 1, wherein the pressure-sensitive adhesive layer contains a rubber-based polymer selected from a styrene-based thermoplastic elastomer, an isobutylene-based polymer, and a combination thereof.

3. The pressure-sensitive adhesive tape according to claim 1, wherein the pressure-sensitive adhesive layer contains at least one wavelength conversion material having a center emission wavelength in a wavelength band ranging from 515 nm to 650 nm.

4. The pressure-sensitive adhesive tape according to claim 3,
wherein the pressure-sensitive adhesive layer contains at least two wavelength conversion materials including a first wavelength conversion material and a second wavelength conversion material, and
wherein the first wavelength conversion material has a center emission wavelength in a wavelength band ranging from 515 nm to 550 nm, and the second wavelength conversion material has a center emission wavelength in a wavelength band ranging from 605 nm to 650 nm.

5. The pressure-sensitive adhesive tape according to claim 1, wherein the pressure-sensitive adhesive layer contains a layered silicate subjected to organizing treatment.

6. The pressure-sensitive adhesive tape according to claim 1, wherein the pressure-sensitive adhesive layer has a water vapor transmission rate in terms of a thickness of 50 μm of 100 g/(m²·day) or less.

7. The pressure-sensitive adhesive tape according to claim 1, wherein the pressure-sensitive adhesive layer has a thickness of 20 μm or more.

8. A pressure-sensitive adhesive tape for preventing light leakage of a liquid crystal display apparatus having a wavelength conversion function, the pressure-sensitive adhesive tape comprising the following property:
an emission intensity obtained when light having a predetermined wavelength enters the pressure-sensitive adhesive tape is equal to or lower than an emission intensity obtained through the wavelength conversion function of the liquid crystal display apparatus when light having the predetermined wavelength enters the liquid crystal display apparatus.

9. A pressure-sensitive adhesive tape, comprising:
a base material; and
a pressure-sensitive adhesive layer having a wavelength conversion function,
wherein the base material has a water vapor transmission rate of 1 g/(m²·day) or less,
wherein the pressure-sensitive adhesive layer has a thickness of 20 μm or more, and has a water vapor transmission rate in terms of a thickness of 50 μm of 100 g/(m²·day) or less,
wherein the pressure-sensitive adhesive layer contains at least two wavelength conversion materials including a first wavelength conversion material and a second wavelength conversion material, and
wherein the first wavelength conversion material includes first quantum dots each having a center emission wavelength in a wavelength band ranging from 515 nm to 550 nm, and the second wavelength conversion material includes second quantum dots each having a center emission wavelength in a wavelength band ranging from 605 nm to 650 nm.

10. The pressure-sensitive adhesive tape according to claim 9, wherein a barrier layer is arranged on at least one side of the base material.

11. The pressure-sensitive adhesive tape according to claim 9, wherein:
when the pressure-sensitive adhesive tape is applied to a liquid crystal display apparatus having a wavelength conversion function, the pressure-sensitive adhesive tape comprising the following property:
an emission intensity obtained when light having a predetermined wavelength enters the pressure-sensitive adhesive tape is equal to or lower than an emission intensity obtained through the wavelength conversion function of the liquid crystal display apparatus when light having the predetermined wavelength enters the liquid crystal display apparatus.
